(19) United States
(12) Patent Application Publication
(10) Pub. No.: US 2021/0245305 A1
(43) Pub. Date: Aug. 12, 2021

(54) SOLDER ALLOY, SOLDER POWDER, SOLDER PASTE, AND A SOLDER JOINT USING THESE

(71) Applicant: SENJU METAL INDUSTRY CO., LTD., Adachi-ku, Tokyo (JP)

(72) Inventors: Hiroyoshi Kawasaki, Tokyo (JP); Osamu Munekata, Tokyo (JP); Masato Shiratori, Tokyo (JP)

(73) Assignee: SENJU METAL INDUSTRY CO., LTD., Adachi-ku, Tokyo (JP)

(21) Appl. No.: 17/261,558

(22) PCT Filed: May 27, 2019
(86) PCT No.: PCT/JP2019/020798

§ 371 Date: Jan. 19, 2021

(30) Foreign Application Priority Data
Jul. 20, 2018 (JP) 2018-136542

(51) Int. Cl. B23K 35/26; C22C 13/02

(52) U.S. Cl. CPC B23K 35/264; C22C 13/02

(57) ABSTRACT

A solder alloy having an alloy composition including at least one of As: 25 to 300 mass ppm, Pb: more than 0 mass ppm and 5100 mass ppm or less, and Sb: more than 0 mass ppm and 3000 mass ppm or less, and moreover Bi: more than 0 mass ppm and 10000 mass ppm or less, as well as a balance including Sn, wherein expression (1) and expression (2) below are satisfied:

275≤2As+Sb+Bi+Pb (1)

0.01≤(2As+Sb)/(Bi+Pb)≤10.00 (2)
where in the expression (1) and the expression (2), As, Sb, Bi, and Pb each represent a content (mass ppm) in the alloy composition.

### TECHNICAL FIELD

The present invention relates to a solder alloy, a solder powder, a solder paste suppressed in change in paste over time, having excellent wettability, and exhibiting a small difference in temperature between liquidus temperature and solidus temperature, and relates to a solder joint using the same.

### BACKGROUND ART

In recent years, demand for miniaturization and higher performances in an electronic device having a solder joint such as a CPU (Central Processing Unit) is on the rise. Accordingly, it has become necessary to miniaturize a printed substrate and an electrode of an electronic device. The electronic device is connected to the printed substrate via the electrode. For this reason, a solder joint connecting these also has to be downsized in accordance with miniaturization of the electrode.

In order to connect an electronic device and a printed substrate via such a fine electrode, a solder paste is generally used. The solder paste is supplied onto the electrode of the printed substrate by printing or the like. Printing of a solder paste is performed in the following manner: a metal mask including an opening provided is placed on a printed substrate; a squeegee is moved while being pressed against the metal mask; thus, the solder paste is applied collectively to the electrode on the printed substrate through the opening of the metal mask. Then, the electronic component is mounted on the solder paste printed on the printed substrate, and is held by the solder paste until completion of soldering.

Then, for example, when it takes several hours for the electronic component to be introduced into a reflow oven after being mounted on the printed substrate, the solder paste may not be able to retain the shape formed at the time of printing due to the change in the solder paste over time. This may cause inclination or poor joint of the electronic component. Further, in a case of a purchased solder paste, generally, the solder paste is normally not entirely used up in one printing operation. For this reason, the solder paste has to keep the original proper viscosity exhibited at the time of manufacturing so as not to impair printing performance.

However, in recent years, with advance of miniaturization of the electrode, the printing area of the solder paste has also become smaller. Accordingly, the elapse of time until the purchased solder paste is used up increases. The solder paste is obtained by kneading a solder powder and a flux. When the storage period of the solder paste thereof is lengthy, the viscosity thereof may increase according to storage conditions. Accordingly, the solder paste may be unable to exhibit the original printing performance at the time of purchasing.

Under such circumstances, for example, Patent Document 1 discloses a solder alloy including Sn, and one or two or more selected from the group consisting of Ag, Bi, Sb, Zn, In, and Cu, and including a prescribed amount of As for suppressing a change in solder paste over time. The patent document discloses the result that the viscosity after two weeks at 25° C. is less than 140% as compared with the original viscosity at the time of manufacturing.

### CITATION LIST

### Patent Document

Patent Document 1: Patent Publication JP-A 2015-98052

### SUMMARY

### Technical Problem

As described above, the invention according to Patent Document 1 is a solder alloy which may selectively include six elements other than Sn and As. Further, the patent document discloses the result that a large As content results in inferior fusibility.

Herein, the fusibility evaluated in Patent Document 1 is considered equivalent to wettability of fused solder. The fusibility disclosed in the patent document is evaluated by the presence or absence of solder powder not fully fused as indicated by observing, with a microscope, outward appearance of the fused material. This is because the high wettability of the fused solder makes it difficult for the solder powder that is not fully fused to be remained.

Generally, in order to improve the wettability of a fused solder, it is necessary to use a high activity flux. With regard to the flux described in Patent Document 1, it is considered that deterioration of the wettability due to As may be suppressed only by use of a high activity flux. However, use of a high activity flux results in an increase in viscosity increase rate of the flux. Further, in view of the description of Patent Document 1, suppression of the increase in a viscosity increase rate requires an increase in As content. In order for the solder paste described in Patent Document 1 to exhibit both a still lower viscosity increase rate and excellent wettability, it is necessary to continue therein an increase in the activity of the flux and the As content, but this may lead to a vicious circle.

Recently, a solder paste has been required to keep exhibiting stable performances for a long term irrespective of the usage environment or storage environment, and has also been required to have higher wettability because of further miniaturization of the solder joint. When the recent requirements are tried to be dealt with by using the solder paste described in Patent Document 1, as described above, a vicious circle is unavoidable.

Further, in order to join fine electrodes, it is necessary to improve, for instance, the mechanical characteristics of the solder joint. Depending on elements, an increase in content results in an increase in liquidus temperature, thereby the difference between the liquidus temperature and the solidus temperature broaden. This causes segregation upon solidification, resulting in the formation of an ununiform alloy structure. When a solder alloy has such an alloy structure, mechanical characteristics such as tensile strength are reduced, and the solder alloy may be easily broken by an external stress. This problem has become more evident due to the recent downsizing of the electrode.

An object of the present invention is to provide a solder alloy, a solder powder, and a solder paste that are suppressed in change in paste over time, excellent in wettability, small in temperature difference between liquidus temperature and solidus temperature and have high mechanical characteristics, and also provides a solder joint using the same.

### Solution to Problem

For improving both the suppression of change in paste over time and excellent wettability at the same time, it is necessary to avoid a vicious circle due to the use of a flux having a high activity, and an increase in As content. The present inventors focused on the alloy composition of a solder powder, and conducted a diligent study in order to attain balance between the suppression of change in paste over time, and the excellent wettability irrespective of flux type.

First, the present inventors conducted a study on a solder powder including, as a basic composition, Sn, SnCu, SnAgCu solder alloy, which is conventionally used as a solder alloy, and also including As. Then, the present inventors paid attention to the reason why the change in solder paste over time is suppressed when the solder powder is used, and looked into an amount of As content.

It is considered that the reason why the viscosity of the solder paste increases over time is that the solder powder and the flux react with each other. Comparison between the results of Example 4 and Comparative Example 2 of Table 1 of Patent Document 1 indicates the result that an As content of more than 100 mass ppm results in a lower viscosity increase rate. In view of this, the present inventors considered that when attention is paid to the effect of suppressing the change in paste over time (which will be hereinafter referred to as “thickening suppressing effect” as appropriate), it would be appropriate to increase the As content further. It has been confirmed that when the As content is increased, the thickening suppressing effect slightly increases in accordance with the As content, but when the As content is too high, the wettability of the solder alloy is deteriorated.

Under such circumstances, the present inventors came to realize that, other than As, an element exhibiting the thickening suppressing effect has to be added, and searched for various elements. The present inventors happened to find that Sb, Bi, and Pb exhibit the same effects as those of As. Although the reason for this is not definite, it can be presumed as follows.

The thickening suppressing effect is exhibited by suppressing a reaction with the flux. Accordingly, as the element having low reactivity with the flux, there is an element having a low ionization tendency. Generally, the ionization of an alloy is considered on the basis of ionization tendency as an alloy composition, namely, standard electrode potential. For example, a SnAg alloy including Ag which is noble relative to Sn is less likely to be ionized than Sn. For this reason, the alloy having an element more noble than Sn is less likely to be ionized, and is presumed to have a high thickening suppressing effect in the solder paste.

Herein, in Patent Document 1, Bi, Sb, Zn, and In are exemplified as equivalent elements other than Sn, Ag, and Cu. In terms of the ionization tendency, In and Zn are elements less noble relative to Sn. In other words, Patent Document 1 describes that even when an element less noble than Sn is added, the thickening suppressing effect can be obtained. For this reason, it is considered that the solder alloy including an element selected according to the ionization tendency can provide the thickening suppressing effect equivalent to or more than that of the solder alloy described in Patent Document 1. Further, as described above, an increase in As content results in the deterioration of the wettability.

The present inventors conducted a detailed examination on Bi and Pb to find a thickening suppressing effect. Bi and Pb reduce the liquidus temperature of the solder alloy, hence improves the wettability of the solder alloy when the heating temperature of the solder alloy is constant. However, the solidus temperature drops significantly depending on the content. For this reason, ΔT which is the temperature difference between the liquidus temperature and the solidus temperature becomes too large. A too large ΔT causes segregation during solidification, and this leads to the reduction of the mechanical characteristics such as the mechanical strength. The phenomenon in which the ΔT broadens appears significantly when Bi and Pb are added at the same time. Accordingly, it has also been found that strict control is necessary.

Further, the present inventors conducted a reexamination on the Bi content and the Pb content in order to improve the wettability of solder alloy, and found that an increase in the contents of the elements broadens the ΔT. Thus, the present inventors selected Sb as an element which is noble in ionization tendency relative to Sn, and also as an element which improves the wettability of the solder alloy, and defined the allowable range of the Sb content, then conducted a detailed examination on a relationship concerning respective contents of As, Bi, Pb including Sb, and respective Sb contents therein. As a result, the present inventors happened to find that when the contents of the elements satisfy a prescribed relational expression, no practical problems are caused in excellent thickening suppressing effect, wettability, and narrowing of the ΔT, thereby leading to the completion of the present invention.

The present invention obtained from the findings is as follows.

(1) A solder alloy having an alloy composition including at least one of As: 25 to 300 mass ppm, Pb: more than 0 mass ppm and 5100 mass ppm or less, and Sb: more than 0 mass ppm and 3000 mass ppm or less, and moreover Bi: more than 0 mass ppm and 10000 mass ppm or less, as well as a balance including Sn, wherein expression (1) and expression (2) below are satisfied:

275≤2As+Sb+Bi+Pb (1)

0.01≤(2As+Sb)/(Bi+Pb)≤10.00 (2)

where in the expression (1) and the expression (2), As, Sb, Bi, and Pb each represent a content (mass ppm) in the alloy composition.

(2) The solder alloy according to the (1), in which the alloy composition further satisfies expression (1a) below:

275≤2As+Sb+Bi+Pb≤25200 (1a)

where in the expression (1a), As, Sb, Bi, and Pb each represent a content (mass ppm) in the alloy composition.

(3) The solder alloy according to the (1), in which the alloy composition further satisfies expression (1b) below:

275≤2As+Sb+Bi+Pb≤5300 (1b)

where in the expression (1b), As, Bi, and Pb each represent a content (mass ppm) in the alloy composition.

(4) The solder alloy according to any one of the (1) to (3), in which the alloy composition further satisfies expression (2a) below:

0.31≤(2As+Sb)/(Bi+Pb)≤10.00 (2a)

where in the expression (2a), As, Sb, Bi, and Pb each represent a content (mass ppm) in the alloy composition.

(5) The solder alloy according to any one of the (1) to (4), in which the alloy composition further includes at least one of Ag: 0 to 4 mass % and Cu: 0 to 0.9 mass %.

(6) A solder powder having the solder alloy according to any one of the (1) to (5).

(7) A solder paste having the solder powder according to the (6).

(8) The solder paste according to the (7), further having a zirconium oxide powder.

(9) The solder paste according to the (8), including the zirconium oxide powder in an amount of 0.05 to 20.0 mass % based on a total mass of the solder paste.

(10) A solder joint having the solder alloy according to any one of the (1) to (5).

### DESCRIPTION OF EMBODIMENTS

The present invention will be described in more details below. In the present specification, “ppm” for the solder alloy composition represents “mass ppm” unless otherwise specified. “%” represents “mass %” unless otherwise specified.

1. Alloy Composition

(1) As: 25 to 300 ppm

As is an element capable of suppressing a change in solder paste over time. As is an element having low reactivity with a flux, and noble relative to Sn, and hence presumably can exhibit the thickening suppressing effect. When As is in an amount of less than 25 ppm, the thickening suppressing effect cannot be sufficiently exhibited. The lower limit of the As content is 25 ppm or more, preferably 50 ppm or more, and more preferably 100 ppm or more. On the other hand, a too high As content results in deterioration of the wettability of the solder alloy. The upper limit of the As content is 300 ppm or less, preferably 250 ppm or less, and more preferably 200 ppm or less.

(2) At Least One of Pb: More than 0 Mass ppm and 5100 Mass ppm or Less, and Sb: More than 0 Mass ppm and 3000 Mass ppm or Less, and Bi: More than 0 Mass ppm and 10000 Mass ppm or Less

Sb is an element having low reactivity with a flux, and exhibiting the thickening suppressing effect. When the solder alloy in accordance with the present invention includes Sb, the lower limit of the Sb content is more than 0 ppm, preferably 25 ppm or more, more preferably 50 ppm or more, further preferably 100 ppm or more, and in particular preferably 300 ppm or more. On the other hand, a too high Sb content results in the deterioration of the wettability. For this reason, the Sb content is required to be set at a proper content. The upper limit of the Sb content is 3000 ppm or less, preferably 1150 ppm or less, and more preferably 500 ppm or less.

Bi and Pb are each an element having low reactivity with a flux, and exhibiting the thickening suppressing effect as with Sb. Further, Bi and Pb are each an element which reduces the liquidus temperature of a solder alloy, and reduces the viscosity of a fused solder, and hence can suppress the deterioration of the wettability by As.

When at least one element of Pb, and Sb and Bi is present, the deterioration of the wettability by As can be suppressed. When the solder alloy in accordance with the present invention includes Bi, the lower limit of the Bi content is more than 0 ppm, preferably 25 ppm or more, more preferably 50 ppm or more, further preferably 75 ppm or more, in particular preferably 100 ppm or more, and most preferably 250 pp or more. The lower limit of the Pb content is more than 0 ppm, preferably 25 ppm or more, more preferably 50 ppm or more, further preferably 75 ppm or more, in particular preferably 100 ppm or more, and most preferably 250 pp or more.

On the other hand, a too high content of the elements results in a remarkable reduction of the solidus temperature. For this reason, the ΔT of the temperature difference between the liquidus temperature and the solidus temperature becomes too broad. A too broad ΔT results in precipitation of a high melting point crystal phase with a low content of Bi or Pb during the solidification process of the fused solder. Accordingly, liquid-phase Bi or Pb is concentrated. Then, when the temperature of the fused solder is further reduced, the low melting point crystal phase with a high concentration of Bi or Pb is segregated. For this reason, the mechanical strength of the solder alloy or the like is deteriorated, resulting in inferior reliability. Particularly, the crystal phase with a high Bi concentration is hard and brittle. For this reason, when the crystal phase is segregated in the solder alloy, the reliability is remarkably reduced.

From such a viewpoint, when the solder alloy in accordance with the present invention includes Bi, the upper limit of the Bi content is 10000 ppm or less, preferably 1000 ppm or less, more preferably 600 ppm or less, and further preferably 500 ppm or less. The upper limit of the Pb content is 5100 ppm or less, preferably 5000 ppm or less, more preferably 1000 ppm or less, further preferably 850 ppm or less, and in particular preferably 500 ppm or less.

(3) Expression (1)

The solder alloy in accordance with the present invention is required to satisfy the following expression (1).

275≤2As+Sb+Bi+Pb (1)

In the expression (1), As, Sb, Bi, and Pb each represent the content (mass ppm) in the alloy composition.

As, Sb, Bi, and Pb are all the elements exhibiting the thickening suppressing effect. Thickness suppression requires a total content thereof of 275 ppm or more. The reason why the As content in the expression (1) is doubled is because As provides a higher thickening suppressing effect than that of Sb, Bi, or Pb.

When the expression (1) is less than 275, the thickening suppressing effect is not sufficiently exerted. The lower limit of the expression (1) is 275 or more, preferably 350 or more, and more preferably 1200 or more. On the other hand, the upper limit of (1) has no particular restriction from the viewpoint of the thickening suppressing effect, and is preferably 25200 or less, more preferably 10200 or less, further preferably 5300 or less, and in particular preferably 3800 or less from the viewpoint of setting the ΔT within the proper range.

Those obtained by appropriately selecting the upper limit and the lower limit from the preferable aspects are the following expressions (1a) and (1b).

275≤2As+Sb+Bi+Pb≤25200 (1a)

275≤2As+Sb+Bi+Pb≤5300 (1b)

In the expressions (1a) and (1b), As, Sb, Bi, and Pb each represent the content (mass ppm) for the alloy composition.

(4) Expression (2)

The solder alloy in accordance with the present invention is required to satisfy the following expression (2).

0.01≤(2As+Sb)/(Bi+Pb)≤10.00 (2)

In the expression (2), As, Sb, Bi, and Pb each represent the content (mass ppm) for the alloy composition.

A high content of As and Sb results in the deterioration of the wettability of a solder alloy. On the other hand, Bi and Pb suppress the deterioration of the wettability due to inclusion of As. However, a too high content thereof results in an increase in ΔT. For this reason, strict control is necessary. Particularly, with the alloy composition including Bi and Pb at the same time, the ΔT tends to increase. In view of these, when the content of Bi and Pb is tried to be increased to excessively improve the wettability, the ΔT is broadened. On the other hand, when the content of As or Sb is tried to be increased to improve the thickening suppressing effect, the wettability is deteriorated. Thus, in the present invention, the compositions are grouped into a group of As and Sb, and a group of Bi and Pb. When the total amount of both the groups falls within a proper prescribed range, all of the thickening suppressing effect, the narrowing of the ΔT, and the wettability are satisfied at the same time.

When the expression (2) is less than 0.01, the total content of Bi and Pb becomes relatively larger than the total content of As and Pb. For this reason, the ΔT is broadened. The lower limit of the expression (2) is 0.01 or more, preferably 0.02 or more, more preferably 0.41 or more, further preferably 0.90 or more, in particular preferably 1.00 or more, and most preferably 1.40 or more. On the other hand, when the expression (2) exceeds 10.00, the total content of As and Sb becomes relatively larger than the total content of Bi and Pb. For this reason, the wettability is deteriorated. The upper limit of (2) is 10.00 or less, preferably 5.33 or less, more preferably 4.50 or less, further preferably 2.67 or less, still more preferably 4.18 or less, and in particular preferably 2.30 or less.

Incidentally, the denominator of the expression (2) is “Bi+Pb”, and the expression (2) does not hold unless these are included. Namely, it results that the solder alloy in accordance with the present invention necessarily includes at least one of Bi and Pb. The alloy composition not including Bi and Pb is inferior in wettability as described previously.

The one obtained by appropriately selecting the upper limit and the lower limit from the preferable aspects is the following the expression (2a).

0.31≤(2As+Sb)/(Bi+Pb)≤10.00 (2a)

In the expression (2a), Bi and Pb each represent the content (mass ppm) for the alloy composition.

(4) At Least One of Ag: 0% to 4% and Cu: 0% to 0.9%

Ag is a given element capable of forming Ag₃Sn at the crystal interface, and improving the reliability of the solder alloy. Further, Ag is an element noble in ionization tendency relative to Sn, and coexists with As, Pb, and Bi, and thereby promotes the thickening suppressing effect thereof. The Ag content is preferably 0% to 4%, more preferably 0.5% to 3.5%, and further preferably 1.0% to 3.0%.

Cu is a given element capable of improving the joining strength of the solder joint. Further, Cu is an element noble in ionization tendency relative to Sn, and coexists with As, Pb, and Bi, and thereby promotes the thickening suppressing effect thereof. The Cu content is preferably 0% to 0.9%, more preferably 0.1% to 0.8%%, and further preferably 0.2% to 0.7%.

(5) Balance: Sn

The balance of the solder alloy in accordance with the present invention is Sn. Other than the elements, inevitable impurities may be included therein. Even when inevitable impurities are included, the foregoing effects will not be affected. Further, as described later, even inclusion of the elements not to be included in the present invention as inevitable impurities will not affect the foregoing effect. When In has a too high content, the ΔT is broadened. For this reason, In will not affect the foregoing effect so long as the content is 1000 ppm or less.

2. Solder Powder

The solder powder in accordance with the present invention is used for a solder paste described later. The solder powder in accordance with the present invention preferably satisfies the size satisfying signs 1 to 8 (particle size distribution) in classification of the powder size (Table 2) in JIS Z 3284-1:2014. More preferable is a size satisfying signs 4 to 8 (particle size distribution), and further preferable is a size satisfying signs 5 to 8 (particle size distribution). When the particle size satisfies the conditions, the surface area of the powder is not too large, so that the increase in viscosity may be suppressed, and the aggregation of a fine powder may be suppressed, which may suppress the increase in viscosity. For this reason, soldering to a finer component becomes possible.

3. Solder Paste

The solder paste in accordance with the present invention includes the foregoing solder powder and flux.

(1) The flux for use in the solder paste of the component of the flux includes any of, or a combination of two or more of an organic acid, amine, amine hydrohalic acid salt, organic halogen compound, thixotropic agent, rosin, solvent, surfactant, base agent, high molecular compound, silane coupling agent, and coloring agent.

As the organic acid, mention may be made of succinic acid, glutaric acid, adipic acid, pimelic acid, suberic acid, azelaic acid, sebacic acid, dimer acid, propionic acid, 2,2-bishydroxymethyl propionic acid, tartaric acid, malic acid, glycolic acid, diglycolic acid, thioglycolic acid, dithioglycolic acid, stearic acid, 12-hydroxy stearic acid, palmitic acid, oleic acid, or the like.

As the amine, mention may be made of ethylamine, triethylamine, ethylene diamine, triethylenetetramine, 2-methyl imidazole, 2-undecyl imidazole, 2-heptadecyl imidazole, 1,2-dimethyl imidazole, 2-ethyl-4-methyl imidazole, 2-phenyl imidazole, 2-phenyl-4-methyl imidazole, 1-benzyl-2-methyl imidazole, 1-benzyl-2-phenyl imidazole, 1-cyano ethyl-2-methyl imidazole, 1-cyano ethyl-2-undecyl imidazole, 1-cyano ethyl-2-ethyl-4-methyl imidazole, 1-cyano ethyl-2-phenyl imidazole, 1-cyano ethyl-2-undecyl imidazolium trimellitate, 1-cyano ethyl-2-phenyl imidazolium trimellitate, 2,4-diamino-6-[2′-methyl imidazolyl-(1′)]-ethyl-s-triazine, 2,4-diamino-6-[2′-undecyl imidazolyl-(1′)]-ethyl-s-triazine, 2,4-diamino-6-[2′-ethyl-4′-methyl imidazolyl-(1′)]-ethyl-s-triazine, 2,4-diamino-6-[2′-methyl imidazolyl-(1′)]-ethyl-s-triazine isocyanuric acid adduct, 2-phenyl imidazole isocyanuric acid adduct, 2-phenyl-4, 5-dihydroxymethyl imidazole, 2-phenyl-4-methyl-5-hydroxymethyl imidazole, 2,3-dihydro-1H-pyrrolo[1,2-a]benzimidazole, 1-dodecyl-2-methyl-3-benzyl imidazolium chloride, 2-methyl imidazoline, 2-phenyl imidazoline, 2,4-diamino-6-vinyl-s-triazine, 2,4-diamino-6-vinyl-s-triazine isocyanuric acid adduct, 2,4-diamino-6-methacryloyloxyethyl-s-triazine, epoxy-imidazole adduct, 2-methyl benzimidazole, 2-octyl benzimidazole, 2-pentyl benzimidazole, 2-(1-ethyl pentyl)benzimidazole, 2-nonyl benzimidazole, 2-(4-thiazolyl)benzimidazole, benzimidazole, 2-(2′-hydroxy-5′-methyl phenyl)benzotriazole, 2-(2′-hydroxy-3′-tert-butyl-5′-methyl phenyl)-5-chlorobenzotriazole, 2-(2′-hydroxy-3′, 5′-di-tert-amyl phenyl)benzotriazole, 2-(2′-hydroxy-5′-tert-octyl phenyl)benzotriazole, 2,2′-methylenebis [6-(2H-benzotriazole-2-yl)-4-tert-octyl phenol], 6-(2-benzotriazolyl)-4-tert-octyl-6′-tert-butyl-4′-methyl-2,2′-methylene bisphenol, 1,2,3-benzotriazole, 1-[N, N-bis(2-ethylhexyl)amino methyl]benzotriazole, carboxy benzotriazole, 1-[N, N-bis(2-ethylhexyl)amino methyl]methyl benzotriazole, 2,2′-[[(methyl-1H-benzotriazole-1-yl)methyl]imino]bisethanol, 1-(1′,2′-dicarboxyethyl)benzotriazole, 1-(2,3-dicarboxy propyl)benzotriazole, 1-[(2-ethylhexyl amino)methyl]benzotriazole, 2,6-bis[(1H-benzotriazole-1-yl)methyl]-4-methyl phenol, 5-methyl benzotriazole, 5-phenyl tetrazole, or the like.

The amine hydrohalic acid salt is a compound obtained by allowing amine and hydrogen halide to react with each other. As amine, mention may be made of ethylamine, ethylene diamine, triethylamine, methyl imidazole, 2-ethyl-4-methyl imidazole, or the like. As hydrogen halide, mention may be made of hydride of chlorine, bromine, or iodine.

As the organic halogen compound, mention may be made of 1-bromo-2-butanol, 1-bromo-2-propanol, 3-bromo-1-propanol, 3-bromo-1,2-propane diol, 1,4-dibromo-2-butanol, 1,3-dibromo-2-propanol, 2,3-dibromo-1-propanol, 2,3-dibromo-1,4-butane diol, 2,3-dibromo-2-butene-1,4-diol, or the like.

As the thixotropic agent, mention may be made of a wax type thixotropic agent, or an amide type thixotropic agent. Examples of the wax type thixotropic agent may include a castor hardened oil. As the amide type thixotropic agent, mention may be made of amide laurate, amide palmitate, amide stearate, amide behenate, amide hydroxystearate, saturated fatty acid amide, oleic amide, erucic amide, unsaturated fatty acid amide, p-toluene methane amide, aromatic amide, methylenebis amide stearate, ethylenebis lauric amide, ethylene bishydroxystearate amide, saturated fatty acid bisamide, methylenebis oleic amide, unsaturated fatty acid bisamide, m-xylylene bisstearic amide, aromatic bisamide, saturated fatty acid polyamide, unsaturated fatty acid polyamide, aromatic polyamide, substituted amide, methylol stearic amide, methylolamide, fatty acid ester amide, or the like.

As the base agent, mention may be made of polyethylene glycol, rosin, or the like. Examples of the rosin may include raw material rosins such as gum rosin, wood rosin, and tall oil rosin, and derivatives obtained from the raw material rosins. Examples of the derivative may include purified rosin, hydrogenated rosin, disproportionated rosin, polymerized rosin, and α, β unsaturated carboxylic acid modified products (such as acrylated rosin, maleated rosin, and fumarated rosin), and purified products, hydrides, and disproportionated products of the polymerized rosin, and purified products, hydrides, and disproportionated products of the α, β unsaturated carboxylic acid modified product, and two or more thereof can be used. Further, in addition to the rosin type resins, there can be further included at least one or more resins selected from terpene resin, modified terpene resin, terpene phenol resin, modified terpene phenol resin, styrene resin, modified styrene resin, xylene resin, and modified xylene resin. As the modified terpene resin, there can be used aromatic modified terpene resin, hydrogenated terpene resin, hydrogenated aromatic modified terpene resin, or the like. As the modified terpene phenol resin, hydrogenated terpene phenol resin or the like can be used. As the modified styrene resin, styrene acrylic resin, styrene maleic acid resin, or the like can be used. As the modified xylene resin, mention may be made of phenol modified xylene resin, alkyl phenol modified xylene resin, phenol modified resol type xylene resin, polyol modified xylene resin, polyoxyethylene-added xylene resin, or the like.

As the solvents, mention may be made of water, alcohol type solvent, glycol ether type solvent, and terpineols, and the like. As the alcohol type solvents, mention may be made of isopropyl alcohol, 1,2-butane diol, isobornyl cyclohexanol, 2,4-diethyl-1,5-pentane diol, 2,2-dimethyl-1,3-propane diol, 2,5-dimethyl-2,5-hexane diol, 2,5-dimethyl-3-hexyne-2,5-diol, 2,3-dimethyl-2,3-butane diol, 1,1,1-tris(hydroxymethyl)ethane, 2-ethyl-2-hydroxymethyl-1,3-propane diol, 2,2′-oxybis(methylene)bis(2-ethyl-1,3-propane diol), 2,2-bis(hydroxymethyl)-1,3-propane diol, 1,2,6-trihydroxy hexane, bis[2,2,2-tris(hydroxymethyl)ethyl]ether, 1-ethynyl-1-cyclohexanol, 1,4-cyclohexane diol, 1,4-cyclohexanedimethanol, erythritol, threitol, guaiacol glycerol ether, 3, 6-dimethyl-4-octyne-3, 6-diol, 2,4, 7, 9-tetramethyl-5-decyne-4, 7-diol, and the like. As the glycol ether type solvent, mention may be made of diethylene glycol mono-2-ethylhexyl ether, ethylene glycol monophenyl ether, 2-methyl pentane-2,4-diol, diethylene glycol monohexyl ether, diethylene glycol dibutyl ether, triethylene glycol monobutyl ether, or the like.

As the surfactants, mention may be made of polyoxyalkylene acetylene glycols, polyoxyalkylene glyceryl ether, polyoxyalkylene alkyl ether, polyoxyalkylene ester, polyoxyalkylene alkyl amine, polyoxyalkylene alkyl amide, and the like.

(2) Content of Flux

The content of the flux is preferably 5% to 95%, and more preferably 5% to 15% based on the total mass of the solder paste. When the content falls within this range, the thickening suppressing effect resulting from the solder powder is sufficiently exerted.

(3) Zirconium Oxide Powder

The solder paste in accordance with the present invention preferably includes a zirconium oxide powder. Zirconium oxide can suppress an increase in viscosity of the paste over time. This is presumed due to the fact that inclusion of zirconium oxide allows the oxide film thickness of the solder powder surface to be kept in the state before charging into the flux. Although the details are not known, it is presumed as follows. Generally, the active component of the flux has slight activity even at normal temperature. For this reason, the surface oxide film of the solder powder is reduced in thickness by reduction, which causes aggregation of powders. Thus, addition of a zirconium oxide powder to the solder paste allows the active component of the flux to react preferentially with the zirconium oxide powder. Accordingly, the oxide film thickness is presumably kept to such an extent as to prevent the oxide film at the solder powder surface from being aggregated.

In order for such advantageous effects to be sufficiently exerted, the content of the zirconium oxide powder in the solder paste is preferably 0.05% to 20.0% based on the total mass of the solder paste. When the content is 0.05% or more, the advantageous effects can be exerted. When the content is 20.0% or less, the content of the metal powder can be ensured, and the thickening preventing effect can be exerted. The content of the zirconium oxide is preferably 0.05% to 10.0%, and the more preferable content is 0.1% to 3%.

The particle size of the zirconium oxide powder in the solder paste is preferably 5 μm or less. When the particle size is 5 μm or less, the printability of the paste can be kept. Although the lower limit has no particular restriction, the lower limit may only be 0.5 μm or more. For the particle size, a SEM photograph of the zirconium oxide powder was taken, and the projected circle equivalent diameters were determined by image analysis for respective 0.1-μm or more powders, and the average value thereof was adopted.

The shape of the zirconium oxide has no particular restriction. When the shape is an irregular shape, the contact area with the flux is large, which produces the thickening suppressing effect. A spherical shape provides favorable flowability, resulting in excellent printability as a paste. The shape may be appropriately selected according to the desired characteristics.

(4) Method for Manufacturing Solder Paste

The solder paste in accordance with the present invention is manufactured by a method common in the art. First, for manufacturing a solder powder, known methods can be adopted such as a dropping method in which a fused solder material is added dropwise, resulting in particles, a spray method in which centrifugal spraying is performed, and a method in which a bulk solder material is crushed. With the dropping method, or the spray method, dropwise addition or spraying is preferably performed in an inert atmosphere or a solvent for providing a particulate shape. Then, the respective components are mixed with heating, thereby preparing a flux. To the resulting flux, the solder powder, and in some cases, a zirconium oxide powder are introduced, and mixed with stirring. As a result, the solder paste can be manufactured.

4. Solder Joint

The solder joint in accordance with the present invention is suitable for use in connection between an IC chip and the substrate (interposer) in a semiconductor package, or connection with a semiconductor package and a printed wiring board. Herein, the “solder joint” represents the connection part of the electrode.

5. Others

The solder alloy in accordance with the present invention may be in a wire shape other than being used as the solder powder as described above.

The method for manufacturing a solder joint in accordance with the present invention may be performed according to the ordinary method.

The joining method using the solder paste in accordance with the present invention may be performed using, for example, a reflow method according to the normal method. The fusing temperature of the solder alloy for performing flow soldering may be generally a temperature higher than the liquidus temperature by about 20° C. Further, when joining is performed using the solder alloy in accordance with the present invention, the cooling rate for solidification is more preferably considered from the viewpoint of miniaturization of the structure. For example, the solder joint is cooled at a cooling rate of 2° C./s to 3° C./s or more. Other joining conditions can be appropriately adjusted according to the alloy composition of the solder alloy.

The solder alloy in accordance with the present invention can manufacture a low α-ray dose alloy by using a low α-ray dose material as the raw material. When such a low α-ray dose alloy is used for formation of the solder bump around the memory, it becomes possible to suppress a software error.

### Examples

The present invention will be described by way of the following examples. The present invention is not limited to the following examples.

A solder paste was manufactured by mixing a flux and a solder powder, with the flux being prepared with 42 parts by mass of a rosin, 35 parts by mass of a glycol type solvent, 8 parts by mass of a thixotropic agent, 10 parts by mass of an organic acid, 2 parts by mass of an amine, and 3 parts by mass of a halogen; and a solder powder including each alloy composition shown in Table 1 to Table 6, and having a size (particle size distribution) satisfying sign 4 in the classification of the powder size (Table 2) in JIS Z 3284-1:2014. The were mixed, thereby manufacturing. The mass ratio of the flux and the solder powder was flux:solder powder=11:89. Each solder paste was measured for the change in viscosity over time. Further, the liquidus temperature and the solidus temperature of the solder powder were measured. Further, using the solder paste immediately after manufacturing, the wettability was evaluated. The details are as follows.

Change Over Time

For each solder paste immediately after manufacturing, using PCU-205 manufactured by Malcom Co., Ltd., the viscosity was measured at rotations per minute: 10 rpm, and at 25° C., in air for 12 hours. The case where the viscosity after 12 hours was 1.2 times or less than the viscosity upon an elapse of 30 minutes after manufacturing the solder paste was evaluated as “AA” as the case where a sufficient thickening suppressing effect was obtained. The case of more than 1.2 times was evaluated as “CC”.

ΔT

For the solder powder before mixing with the flux, DSC measurement was performed using a model: EXSTAR DSC7020 manufactured by SII nanotechnology Inc., in a sample amount: about 30 mg, and at a heating rate: 15° C./min, thereby obtaining the solidus temperature and the liquidus temperature. The solidus temperature was subtracted from the resulting liquidus temperature, thereby determining the ΔT. The case where the ΔT was 10° C. or less was evaluated as “AA”, and the case of more than 10° C. was evaluated as “CC”.

Wettability

Each solder paste immediately after manufacturing was printed on a Cu sheet, and was heated from 25° C. to 260° C. in a N₂ atmosphere in a reflow oven at a heating rate of 1° C./s, and then was cooled to room temperature. By observing the outward appearance of the solder bump after cooling by an optical microscope, the wettability was evaluated. The case where the solder powder not fully fused was not observed was evaluated as “AA”. The case where the solder powder not fully fused was observed was evaluated as “CC”.

The results of the evaluation are shown in Table 1.

TABLE 1

| | | | | | | | | Evaluation item | | | |
|---|---|---|---|---|---|---|---|---|---|---|---|
| | | | | | | Expres- | Express- | Change | | Wet- | |
| | Alloy composition (mass ppm) | | | | | sion | ion | over | | tabil- | Comp. |
| | Sn | As | Sb | Bi | Pb | (1) | (2) | time | ΔT | ity | evaluation |
| Ex. 1 | Bal | 100 | 25 | 25 | 25 | 275 | 4.50 | AA | AA | AA | AA |
| Ref. Ex. 2 | Bal | 100 | 50 | 25 | 0 | 275 | 10.00 | AA | AA | AA | AA |
| Ref. Ex. 3 | Bal | 100 | 0 | 75 | 0 | 275 | 2.67 | AA | AA | AA | AA |
| Ex. 4 | Bal | 100 | 0 | 0 | 75 | 275 | 2.67 | AA | AA | AA | AA |
| Ex. 5 | Bal | 100 | 50 | 50 | 50 | 350 | 2.50 | AA | AA | AA | AA |
| Ex. 6 | Bal | 50 | 100 | 100 | 50 | 350 | 1.33 | AA | AA | AA | AA |
| Ex. 7 | Bal | 300 | 0 | 300 | 300 | 1200 | 1.00 | AA | AA | AA | AA |
| Ex. 8 | Bal | 200 | 300 | 250 | 250 | 1200 | 1.40 | AA | AA | AA | AA |
| Ex. 9 | Bal | 100 | 500 | 250 | 250 | 1200 | 1.40 | AA | AA | AA | AA |
| Ex. 10 | Bal | 200 | 50 | 600 | 850 | 1900 | 0.31 | AA | AA | AA | AA |
| Ex. 11 | Bal | 200 | 500 | 500 | 500 | 1900 | 0.90 | AA | AA | AA | AA |
| Ref. Ex. 12 | Bal | 200 | 500 | 1000 | 0 | 1900 | 0.90 | AA | AA | AA | AA |
| Ex. 13 | Bal | 200 | 500 | 0 | 1000 | 1900 | 0.90 | AA | AA | AA | AA |
| Ex. 14 | Bal | 25 | 500 | 350 | 1000 | 1900 | 0.41 | AA | AA | AA | AA |
| Ex. 15 | Bal | 100 | 3000 | 300 | 300 | 3800 | 5.33 | AA | AA | AA | AA |
| Ex. 16 | Bal | 100 | 0 | 0 | 5100 | 5300 | 0.04 | AA | AA | AA | AA |
| Ref. Ex. 17 | Bal | 100 | 0 | 10000 | 0 | 10200 | 0.02 | AA | AA | AA | AA |
| Ex. 18 | Bal | 100 | 0 | 10000 | 5000 | 15200 | 0.01 | AA | AA | AA | AA |
| Comp. Ex. 1 | Bal. | 0 | 100 | 100 | 100 | 300 | 0.50 | CC | AA | AA | CC |
| Comp. Ex. 2 | Bal | 25 | 25 | 25 | 25 | 125 | 1.50 | CC | AA | AA | CC |
| Comp. Ex. 3 | Bal | 300 | 500 | 50 | 50 | 1200 | 11.00 | AA | AA | CC | CC |
| Comp. Ex. 4 | Bal | 350 | 1150 | 25 | 25 | 1900 | 37.00 | AA | AA | CC | CC |
| Comp. Ex. 5 | Bal | 800 | 800 | 100 | 100 | 2600 | 12.00 | AA | AA | CC | CC |
| Comp. Ex. 6 | Bal | 250 | 4800 | 1 | 0 | 5301 | 5300.00 | AA | AA | CC | CC |
| Comp. Ex. 7 | Bal | 800 | 3500 | 100 | 100 | 5300 | 25.50 | AA | AA | CC | CC |
| Comp. Ex. 8 | Bal | 100 | 10000 | 1 | 0 | 10201 | 10200.00 | AA | AA | CC | CC |
| Comp. Ex. 9 | Bal | 100 | 100 | 25000 | 25000 | 50300 | 0.01 | AA | CC | AA | CC |
| Comp. Ex. 10 | Bal | 100 | 100 | 50000 | 0 | 50300 | 0.01 | AA | CC | AA | CC |
| Comp. Ex. 11 | Bal | 100 | 100 | 0 | 50000 | 50300 | 0.01 | AA | CC | AA | CC |
| Comp. Ex. 12 | Bal | 300 | 3000 | 0 | 0 | 3600 | [symbol] | AA | AA | CC | CC |
| Comp. Ex. 13 | Bal. | 100 | 0 | 100 | 25000 | 25300 | 0.01 | AA | CC | AA | CC |

The underline represents being outside the scope of the present invention.

TABLE 2

| | | | | | | | | | Evaluation item | | | |
|---|---|---|---|---|---|---|---|---|---|---|---|---|
| | Alloy composition (As, Bi, Pb: | | | | | | | | Change | | Wet- | Compre- |
| | mass ppm, Cu: mass %) | | | | | | Expres- | Expres- | over | | tabil- | hensive |
| | Sn | Cu | As | Sb | Bi | Pb | sion (1) | sion (2) | time | ΔT | ity | evaluation |
| Ex. 19 | Bal | 0.7 | 100 | 25 | 25 | 25 | 275 | 4.50 | AA | AA | AA | AA |
| Ref. Ex. 20 | Bal | 0.7 | 100 | 50 | 25 | 0 | 275 | 10.00 | AA | AA | AA | AA |
| Ref. Ex. 21 | Bal | 0.7 | 100 | 0 | 75 | 0 | 275 | 2.67 | AA | AA | AA | AA |
| Ex. 22 | Bal | 0.7 | 100 | 0 | 0 | 75 | 275 | 2.67 | AA | AA | AA | AA |
| Ex. 23 | Bal | 0.7 | 100 | 50 | 50 | 50 | 350 | 2.50 | AA | AA | AA | AA |
| Ex. 24 | Bal | 0.7 | 50 | 100 | 100 | 50 | 350 | 1.33 | AA | AA | AA | AA |
| Ex. 25 | Bal | 0.7 | 300 | 0 | 300 | 300 | 1200 | 1.00 | AA | AA | AA | AA |
| Ex. 26 | Bal | 0.7 | 200 | 300 | 250 | 250 | 1200 | 1.40 | AA | AA | AA | AA |
| Ex. 27 | Bal | 0.7 | 100 | 500 | 250 | 250 | 1200 | 1.40 | AA | AA | AA | AA |
| Ex. 28 | Bal | 0.7 | 200 | 50 | 600 | 850 | 1900 | 0.31 | AA | AA | AA | AA |
| Ex. 29 | Bal | 0.7 | 200 | 500 | 500 | 500 | 1900 | 0.90 | AA | AA | AA | AA |
| Ref. Ex. 30 | Bal | 0.7 | 200 | 500 | 1000 | 0 | 1900 | 0.90 | AA | AA | AA | AA |
| Ex. 31 | Bal | 0.7 | 200 | 500 | 0 | 1000 | 1900 | 0.90 | AA | AA | AA | AA |
| Ex. 32 | Bal | 0.7 | 25 | 500 | 350 | 1000 | 1900 | 0.41 | AA | AA | AA | AA |
| Ex. 33 | Bal | 0.7 | 100 | 3000 | 300 | 300 | 3800 | 5.33 | AA | AA | AA | AA |
| Ex. 34 | Bal | 0.7 | 100 | 0 | 0 | 5100 | 5300 | 0.04 | AA | AA | AA | AA |
| Ref. Ex. 35 | Bal | 0.7 | 100 | 0 | 10000 | 0 | 10200 | 0.02 | AA | AA | AA | AA |
| Ex. 36 | Bal | 0.7 | 100 | 0 | 10000 | 5000 | 15200 | 0.01 | AA | AA | AA | AA |
| Comp. Ex. 14 | Bal. | 0.7 | 0 | 100 | 100 | 100 | 300 | 0.50 | CC | AA | AA | CC |
| Comp. Ex. 15 | Bal | 0.7 | 25 | 25 | 25 | 25 | 125 | 1.50 | CC | AA | AA | CC |
| Comp. Ex. 16 | Bal | 0.7 | 300 | 500 | 50 | 50 | 1200 | 11.00 | AA | AA | CC | CC |
| Comp. Ex. 17 | Bal | 0.7 | 350 | 1150 | 25 | 25 | 1900 | 37.00 | AA | AA | CC | CC |
| Comp. Ex. 18 | Bal | 0.7 | 800 | 800 | 100 | 100 | 2600 | 12.00 | AA | AA | CC | CC |
| Comp. Ex. 19 | Bal | 0.7 | 250 | 4800 | 1 | 0 | 5301 | 5300.00 | AA | AA | CC | CC |
| Comp. Ex. 20 | Bal | 0.7 | 800 | 3500 | 100 | 100 | 5300 | 25.50 | AA | AA | CC | CC |
| Comp. Ex. 21 | Bal | 0.7 | 100 | 10000 | 1 | 0 | 10201 | 10200.00 | AA | AA | CC | CC |
| Comp. Ex. 22 | Bal | 0.7 | 100 | 100 | 25000 | 25000 | 50300 | 0.01 | AA | CC | AA | CC |
| Comp. Ex. 23 | Bal | 0.7 | 100 | 100 | 50000 | 0 | 50300 | 0.01 | AA | CC | AA | CC |
| Comp. Ex. 24 | Bal | 0.7 | 100 | 100 | 0 | 50000 | 50300 | 0.01 | AA | CC | AA | CC |
| Comp. Ex. 25 | Bal | 0.7 | 300 | 3000 | 0 | 0 | 3600 | [symbol] | AA | AA | CC | CC |
| Comp. Ex. 26 | Bal. | 0.7 | 100 | 0 | 100 | 25000 | 25300 | 0.01 | AA | CC | AA | CC |

The underline represents being outside the scope of the present invention.

TABLE 3

| | | | | | | | | | | Evaluation item | | | |
|---|---|---|---|---|---|---|---|---|---|---|---|---|---|
| | Alloy composition (As, Sb, Bi, Pb: | | | | | | | | | Change | | Wet- | |
| | mass ppm, Ag, Cu: mass %) | | | | | | | Expres- | Expres- | over | | tabil- | Comprehensive |
| | Sn | Ag | Cu | As | Sb | Bi | Pb | sion (1) | sion (2) | time | ΔT | ity | evaluation |
| Ex. 37 | Bal | 1 | 0.5 | 100 | 25 | 25 | 25 | 275 | 4.50 | AA | AA | AA | AA |
| Ref. Ex. 38 | Bal | 1 | 0.5 | 100 | 50 | 25 | 0 | 275 | 10.00 | AA | AA | AA | AA |
| Ref. Ex. 39 | Bal | 1 | 0.5 | 100 | 0 | 75 | 0 | 275 | 2.67 | AA | AA | AA | AA |
| Ex. 40 | Bal | 1 | 0.5 | 100 | 0 | 0 | 75 | 275 | 2.67 | AA | AA | AA | AA |
| Ex. 41 | Bal | 1 | 0.5 | 100 | 50 | 50 | 50 | 350 | 2.50 | AA | AA | AA | AA |
| Ex. 42 | Bal | 1 | 0.5 | 50 | 100 | 100 | 50 | 350 | 1.33 | AA | AA | AA | AA |
| Ex. 43 | Bal | 1 | 0.5 | 300 | 0 | 300 | 300 | 1200 | 1.00 | AA | AA | AA | AA |
| Ex. 44 | Bal | 1 | 0.5 | 200 | 300 | 250 | 250 | 1200 | 1.40 | AA | AA | AA | AA |
| Ex. 45 | Bal | 1 | 0.5 | 100 | 500 | 250 | 250 | 1200 | 1.40 | AA | AA | AA | AA |
| Ex. 46 | Bal | 1 | 0.5 | 200 | 50 | 600 | 850 | 1900 | 0.31 | AA | AA | AA | AA |
| Ex. 47 | Bal | 1 | 0.5 | 200 | 500 | 500 | 500 | 1900 | 0.90 | AA | AA | AA | AA |
| Ref. Ex. 48 | Bal | 1 | 0.5 | 200 | 500 | 1000 | 0 | 1900 | 0.90 | AA | AA | AA | AA |
| Ex. 49 | Bal | 1 | 0.5 | 200 | 500 | 0 | 1000 | 1900 | 0.90 | AA | AA | AA | AA |
| Ex. 50 | Bal | 1 | 0.5 | 25 | 500 | 350 | 1000 | 1900 | 0.41 | AA | AA | AA | AA |
| Ex. 51 | Bal | 1 | 0.5 | 100 | 3000 | 300 | 300 | 3800 | 5.33 | AA | AA | AA | AA |
| Ex. 52 | Bal | 1 | 0.5 | 100 | 0 | 0 | 5100 | 5300 | 0.04 | AA | AA | AA | AA |
| Ref. Ex. 53 | Bal | 1 | 0.5 | 100 | 0 | 10000 | 0 | 10200 | 0.02 | AA | AA | AA | AA |
| Ex. 54 | Bal | 1 | 0.5 | 100 | 0 | 10000 | 5000 | 15200 | 0.01 | AA | AA | AA | AA |
| Comp. Ex. 27 | Bal. | 1 | 0.5 | 0 | 100 | 100 | 100 | 300 | 0.50 | CC | AA | AA | CC |
| Comp. Ex. 28 | Bal | 1 | 0.5 | 25 | 25 | 25 | 25 | 125 | 1.50 | CC | AA | AA | CC |
| Comp. Ex. 29 | Bal | 1 | 0.5 | 300 | 500 | 50 | 50 | 1200 | 11.00 | AA | AA | CC | CC |
| Comp. Ex. 30 | Bal | 1 | 0.5 | 350 | 1150 | 25 | 25 | 1900 | 37.00 | AA | AA | CC | CC |
| Comp. Ex. 31 | Bal | 1 | 0.5 | 800 | 800 | 100 | 100 | 2600 | 12.00 | AA | AA | CC | CC |
| Comp. Ex. 32 | Bal | 1 | 0.5 | 250 | 4800 | 1 | 0 | 5301 | 5300.00 | AA | AA | CC | CC |
| Comp. Ex. 33 | Bal | 1 | 0.5 | 800 | 3500 | 100 | 100 | 5300 | 25.50 | AA | AA | CC | CC |
| Comp. Ex. 34 | Bal | 1 | 0.5 | 100 | 10000 | 1 | 0 | 10201 | 10200.00 | AA | AA | CC | CC |
| Comp. Ex. 35 | Bal | 1 | 0.5 | 100 | 100 | 25000 | 25000 | 50300 | 0.01 | AA | CC | AA | CC |
| Comp. Ex. 36 | Bal | 1 | 0.5 | 100 | 100 | 50000 | 0 | 50300 | 0.01 | AA | CC | AA | CC |
| Comp. Ex. 37 | Bal | 1 | 0.5 | 100 | 100 | 0 | 50000 | 50300 | 0.01 | AA | CC | AA | CC |
| Comp. Ex. 38 | Bal | 1 | 0.5 | 300 | 3000 | 0 | 0 | 3600 | [symbol] | AA | AA | CC | CC |
| Comp. Ex. 39 | Bal. | 1 | 0.5 | 100 | 0 | 100 | 25000 | 25300 | 0.01 | AA | CC | AA | CC |

The underline represents being outside the scope of the present invention.

TABLE 4

| | | | | | | | | | | Evaluation item | | | |
|---|---|---|---|---|---|---|---|---|---|---|---|---|---|
| | Alloy composition (As, Sb, Bi, Pb: | | | | | | | | | Change | | | |
| | mass ppm, Ag, Cu: mass %) | | | | | | | Expres- | Expres- | over | | Wet- | Comprehensive |
| | Sn | Ag | Cu | As | Sb | Bi | Pb | sion (1) | sion (2) | time | ΔT | tability | evaluation |
| Ex. 55 | Bal | 2 | 0.5 | 100 | 25 | 25 | 25 | 275 | 4.50 | AA | AA | AA | AA |
| Ref. Ex. 56 | Bal | 2 | 0.5 | 100 | 50 | 25 | 0 | 275 | 10.00 | AA | AA | AA | AA |
| Ref. Ex. 57 | Bal | 2 | 0.5 | 100 | 0 | 75 | 0 | 275 | 2.67 | AA | AA | AA | AA |
| Ex. 58 | Bal | 2 | 0.5 | 100 | 0 | 0 | 75 | 275 | 2.67 | AA | AA | AA | AA |
| Ex. 59 | Bal | 2 | 0.5 | 100 | 50 | 50 | 50 | 350 | 2.50 | AA | AA | AA | AA |
| Ex. 60 | Bal | 2 | 0.5 | 50 | 100 | 100 | 50 | 350 | 1.33 | AA | AA | AA | AA |
| Ex. 61 | Bal | 2 | 0.5 | 300 | 0 | 300 | 300 | 1200 | 1.00 | AA | AA | AA | AA |
| Ex. 62 | Bal | 2 | 0.5 | 200 | 300 | 250 | 250 | 1200 | 1.40 | AA | AA | AA | AA |
| Ex. 63 | Bal | 2 | 0.5 | 100 | 500 | 250 | 250 | 1200 | 1.40 | AA | AA | AA | AA |
| Ex. 64 | Bal | 2 | 0.5 | 200 | 50 | 600 | 850 | 1900 | 0.31 | AA | AA | AA | AA |
| Ex. 65 | Bal | 2 | 0.5 | 200 | 500 | 500 | 500 | 1900 | 0.90 | AA | AA | AA | AA |
| Ref. Ex. 66 | Bal | 2 | 0.5 | 200 | 500 | 1000 | 0 | 1900 | 0.90 | AA | AA | AA | AA |
| Ex. 67 | Bal | 2 | 0.5 | 200 | 500 | 0 | 1000 | 1900 | 0.90 | AA | AA | AA | AA |
| Ex. 68 | Bal | 2 | 0.5 | 25 | 500 | 350 | 1000 | 1900 | 0.41 | AA | AA | AA | AA |
| Ex. 69 | Bal | 2 | 0.5 | 100 | 3000 | 300 | 300 | 3800 | 5.33 | AA | AA | AA | AA |
| Ex. 70 | Bal | 2 | 0.5 | 100 | 0 | 0 | 5100 | 5300 | 0.04 | AA | AA | AA | AA |
| Ref. Ex. 71 | Bal | 2 | 0.5 | 100 | 0 | 10000 | 0 | 10200 | 0.02 | AA | AA | AA | AA |
| Ex. 72 | Bal | 2 | 0.5 | 100 | 0 | 10000 | 5000 | 15200 | 0.01 | AA | AA | AA | AA |
| Comp. Ex. 40 | Bal. | 2 | 0.5 | 0 | 100 | 100 | 100 | 300 | 0.50 | CC | AA | AA | CC |
| Comp. Ex. 41 | Bal | 2 | 0.5 | 25 | 25 | 25 | 25 | 125 | 1.50 | CC | AA | AA | CC |
| Comp. Ex. 42 | Bal | 2 | 0.5 | 300 | 500 | 50 | 50 | 1200 | 11.00 | AA | AA | CC | CC |
| Comp. Ex. 43 | Bal | 2 | 0.5 | 350 | 1150 | 25 | 25 | 1900 | 37.00 | AA | AA | CC | CC |
| Comp. Ex. 44 | Bal | 2 | 0.5 | 800 | 800 | 100 | 100 | 2600 | 12.00 | AA | AA | CC | CC |
| Comp. Ex. 45 | Bal | 2 | 0.5 | 250 | 4800 | 1 | 0 | 5301 | 5300.00 | AA | AA | CC | CC |
| Comp. Ex. 46 | Bal | 2 | 0.5 | 800 | 3500 | 100 | 100 | 5300 | 25.50 | AA | AA | CC | CC |
| Comp. Ex. 47 | Bal | 2 | 0.5 | 100 | 10000 | 1 | 0 | 10201 | 10200.00 | AA | AA | CC | CC |
| Comp. Ex. 48 | Bal | 2 | 0.5 | 100 | 100 | 25000 | 25000 | 50300 | 0.01 | AA | CC | AA | CC |
| Comp. Ex. 49 | Bal | 2 | 0.5 | 100 | 100 | 50000 | 0 | 50300 | 0.01 | AA | CC | AA | CC |
| Comp. Ex. 50 | Bal | 2 | 0.5 | 100 | 100 | 0 | 50000 | 50300 | 0.01 | AA | CC | AA | CC |
| Comp. Ex. 51 | Bal | 2 | 0.5 | 300 | 3000 | 0 | 0 | 3600 | [symbol] | AA | AA | CC | CC |
| Comp. Ex. 52 | Bal. | 2 | 0.5 | 100 | 0 | 100 | 25000 | 25300 | 0.01 | AA | CC | AA | CC |

The underline represents being outside the scope of the present invention.

TABLE 5

| | | | | | | | | | | Evaluation item | | | |
|---|---|---|---|---|---|---|---|---|---|---|---|---|---|
| | Alloy composition (As, Sb, Bi, Pb: | | | | | | | | | Change | | | Compre- |
| | mass ppm, Ag, Cu: mass %) | | | | | | | Expres- | Expres- | over | | Wet- | hensive |
| | Sn | Ag | Cu | As | Sb | Bi | Pb | sion (1) | sion (2) | time | ΔT | tability | evaluation |
| Ex. 73 | Bal | 3 | 0.5 | 100 | 25 | 25 | 25 | 275 | 4.50 | AA | AA | AA | AA |
| Ref. Ex. 74 | Bal | 3 | 0.5 | 100 | 50 | 25 | 0 | 275 | 10.00 | AA | AA | AA | AA |
| Ref. Ex. 75 | Bal | 3 | 0.5 | 100 | 0 | 75 | 0 | 275 | 2.67 | AA | AA | AA | AA |
| Ex. 76 | Bal | 3 | 0.5 | 100 | 0 | 0 | 75 | 275 | 2.67 | AA | AA | AA | AA |
| Ex. 77 | Bal | 3 | 0.5 | 100 | 50 | 50 | 50 | 350 | 2.50 | AA | AA | AA | AA |
| Ex. 78 | Bal | 3 | 0.5 | 50 | 100 | 100 | 50 | 350 | 1.33 | AA | AA | AA | AA |
| Ex. 79 | Bal | 3 | 0.5 | 300 | 0 | 300 | 300 | 1200 | 1.00 | AA | AA | AA | AA |
| Ex. 80 | Bal | 3 | 0.5 | 200 | 300 | 250 | 250 | 1200 | 1.40 | AA | AA | AA | AA |
| Ex. 81 | Bal | 3 | 0.5 | 100 | 500 | 250 | 250 | 1200 | 1.40 | AA | AA | AA | AA |
| Ex. 82 | Bal | 3 | 0.5 | 200 | 50 | 600 | 850 | 1900 | 0.31 | AA | AA | AA | AA |
| Ex. 83 | Bal | 3 | 0.5 | 200 | 500 | 500 | 500 | 1900 | 0.90 | AA | AA | AA | AA |
| Ref. Ex. 84 | Bal | 3 | 0.5 | 200 | 500 | 1000 | 0 | 1900 | 0.90 | AA | AA | AA | AA |
| Ex. 85 | Bal | 3 | 0.5 | 200 | 500 | 0 | 1000 | 1900 | 0.90 | AA | AA | AA | AA |
| Ex. 86 | Bal | 3 | 0.5 | 25 | 500 | 350 | 1000 | 1900 | 0.41 | AA | AA | AA | AA |
| Ex. 87 | Bal | 3 | 0.5 | 100 | 3000 | 300 | 300 | 3800 | 5.33 | AA | AA | AA | AA |
| Ex. 88 | Bal | 3 | 0.5 | 100 | 0 | 0 | 5100 | 5300 | 0.04 | AA | AA | AA | AA |
| Ref. Ex. 89 | Bal | 3 | 0.5 | 100 | 0 | 10000 | 0 | 10200 | 0.02 | AA | AA | AA | AA |
| Ex. 90 | Bal | 3 | 0.5 | 100 | 0 | 10000 | 5000 | 15200 | 0.01 | AA | AA | AA | AA |
| Comp. Ex. 53 | Bal. | 3 | 0.5 | 0 | 100 | 100 | 100 | 300 | 0.50 | CC | AA | AA | CC |
| Comp. Ex. 54 | Bal | 3 | 0.5 | 25 | 25 | 25 | 25 | 125 | 1.50 | CC | AA | AA | CC |
| Comp. Ex. 55 | Bal | 3 | 0.5 | 300 | 500 | 50 | 50 | 1200 | 11.00 | AA | AA | CC | CC |
| Comp. Ex. 56 | Bal | 3 | 0.5 | 350 | 1150 | 25 | 25 | 1900 | 37.00 | AA | AA | CC | CC |
| Comp. Ex. 57 | Bal | 3 | 0.5 | 800 | 800 | 100 | 100 | 2600 | 12.00 | AA | AA | CC | CC |
| Comp. Ex. 58 | Bal | 3 | 0.5 | 250 | 4800 | 1 | 0 | 5301 | 5300.00 | AA | AA | CC | CC |
| Comp. Ex. 59 | Bal | 3 | 0.5 | 800 | 3500 | 100 | 100 | 5300 | 25.50 | AA | AA | CC | CC |
| Comp. Ex. 60 | Bal | 3 | 0.5 | 100 | 10000 | 1 | 0 | 10201 | 10200.00 | AA | AA | CC | CC |
| Comp. Ex. 61 | Bal | 3 | 0.5 | 100 | 100 | 25000 | 25000 | 50300 | 0.01 | AA | CC | AA | CC |
| Comp. Ex. 62 | Bal | 3 | 0.5 | 100 | 100 | 50000 | 0 | 50300 | 0.01 | AA | CC | AA | CC |
| Comp. Ex. 63 | Bal | 3 | 0.5 | 100 | 100 | 0 | 50000 | 50300 | 0.01 | AA | CC | AA | CC |
| Comp. Ex. 64 | Bal | 3 | 0.5 | 300 | 3000 | 0 | 0 | 3600 | [symbol] | AA | AA | CC | CC |
| Comp. Ex. 65 | Bal. | 3 | 0.5 | 100 | 0 | 100 | 25000 | 25300 | 0.01 | AA | CC | AA | CC |

The underline represents being outside the scope of the present invention.

TABLE 6

| | | | | | | | | | | Evaluation item | | | |
|---|---|---|---|---|---|---|---|---|---|---|---|---|---|
| | Alloy composition (As, Sb, Bi, Pb: | | | | | | | | | Change | | | Compre- |
| | mass ppm, Ag, Cu: mass %) | | | | | | | Expres- | Expres- | over | | Wet- | hensive |
| | Sn | Ag | Cu | As | Sb | Bi | Pb | sion (1) | sion (2) | time | ΔT | tability | evaluation |
| Ex. 91 | Bal | 3.5 | 0.5 | 100 | 25 | 25 | 25 | 275 | 4.50 | AA | AA | AA | AA |
| Ref. Ex. 92 | Bal | 3.5 | 0.5 | 100 | 50 | 25 | 0 | 275 | 10.00 | AA | AA | AA | AA |
| Ref. Ex. 93 | Bal | 3.5 | 0.5 | 100 | 0 | 75 | 0 | 275 | 2.67 | AA | AA | AA | AA |
| Ex. 94 | Bal | 3.5 | 0.5 | 100 | 0 | 0 | 75 | 275 | 2.67 | AA | AA | AA | AA |
| Ex. 95 | Bal | 3.5 | 0.5 | 100 | 50 | 50 | 50 | 350 | 2.50 | AA | AA | AA | AA |
| Ex. 96 | Bal | 3.5 | 0.5 | 50 | 100 | 100 | 50 | 350 | 1.33 | AA | AA | AA | AA |
| Ex. 97 | Bal | 3.5 | 0.5 | 300 | 0 | 300 | 300 | 1200 | 1.00 | AA | AA | AA | AA |
| Ex. 98 | Bal | 3.5 | 0.5 | 200 | 300 | 250 | 250 | 1200 | 1.40 | AA | AA | AA | AA |
| Ex. 99 | Bal | 3.5 | 0.5 | 100 | 500 | 250 | 250 | 1200 | 1.40 | AA | AA | AA | AA |
| Ex. 100 | Bal | 3.5 | 0.5 | 200 | 50 | 600 | 850 | 1900 | 0.31 | AA | AA | AA | AA |
| Ex. 101 | Bal | 3.5 | 0.5 | 200 | 500 | 500 | 500 | 1900 | 0.90 | AA | AA | AA | AA |
| Ref. Ex. 102 | Bal | 3.5 | 0.5 | 200 | 500 | 1000 | 0 | 1900 | 0.90 | AA | AA | AA | AA |
| Ex. 103 | Bal | 3.5 | 0.5 | 200 | 500 | 0 | 1000 | 1900 | 0.90 | AA | AA | AA | AA |
| Ex. 104 | Bal | 3.5 | 0.5 | 25 | 500 | 350 | 1000 | 1900 | 0.41 | AA | AA | AA | AA |
| Ex. 105 | Bal | 3.5 | 0.5 | 100 | 3000 | 300 | 300 | 3800 | 5.33 | AA | AA | AA | AA |
| Ex. 106 | Bal | 3.5 | 0.5 | 100 | 0 | 0 | 5100 | 5300 | 0.04 | AA | AA | AA | AA |
| Ref. Ex. 107 | Bal | 3.5 | 0.5 | 100 | 0 | 10000 | 0 | 10200 | 0.02 | AA | AA | AA | AA |
| Ex. 108 | Bal | 3.5 | 0.5 | 100 | 0 | 10000 | 5000 | 15200 | 0.01 | AA | AA | AA | AA |
| Comp. Ex. 66 | Bal. | 3.5 | 0.5 | 0 | 100 | 100 | 100 | 300 | 0.50 | CC | AA | AA | CC |
| Comp. Ex. 67 | Bal | 3.5 | 0.5 | 25 | 25 | 25 | 25 | 125 | 1.50 | CC | AA | AA | CC |
| Comp. Ex. 68 | Bal | 3.5 | 0.5 | 300 | 500 | 50 | 50 | 1200 | 11.00 | AA | AA | CC | CC |
| Comp. Ex. 69 | Bal | 3.5 | 0.5 | 350 | 1150 | 25 | 25 | 1900 | 37.00 | AA | AA | CC | CC |
| Comp. Ex. 70 | Bal | 3.5 | 0.5 | 800 | 800 | 100 | 100 | 2600 | 12.00 | AA | AA | CC | CC |
| Comp. Ex. 71 | Bal | 3.5 | 0.5 | 250 | 4800 | 1 | 0 | 5301 | 5300.00 | AA | AA | CC | CC |
| Comp. Ex. 72 | Bal | 3.5 | 0.5 | 800 | 3500 | 100 | 100 | 5300 | 25.50 | AA | AA | CC | CC |
| Comp. Ex. 73 | Bal | 3.5 | 0.5 | 100 | 10000 | 1 | 0 | 10201 | 10200.00 | AA | AA | CC | CC |
| Comp. Ex. 74 | Bal | 3.5 | 0.5 | 100 | 100 | 25000 | 25000 | 50300 | 0.01 | AA | CC | AA | CC |
| Comp. Ex. 75 | Bal | 3.5 | 0.5 | 100 | 100 | 50000 | 0 | 50300 | 0.01 | AA | CC | AA | CC |
| Comp. Ex. 76 | Bal | 3.5 | 0.5 | 100 | 100 | 0 | 50000 | 50300 | 0.01 | AA | CC | AA | CC |
| Comp. Ex. 77 | Bal | 3.5 | 0.5 | 300 | 3000 | 0 | 0 | 3600 | [symbol] | AA | AA | CC | CC |
| Comp. Ex. 78 | Bal. | 3.5 | 0.5 | 100 | 0 | 100 | 25000 | 25300 | 0.01 | AA | CC | AA | CC |

The underline represents being outside the scope of the present invention.

As shown in Table 1 to Table 6, Examples satisfied all the requirements of the present invention in any alloy composition. Accordingly, it has been indicated that Examples showed the thickening suppressing effect, narrowing of the ΔT, and the excellent wettability.

In contrast, Comparative Examples 1, 14, 27, 40, 53, and 66 did not include As. For this reason, the thickening suppressing effect was not exerted.

For Comparative Examples 2, 15, 28, 41, 54, and 67, the expression (1) was lower than the lower limit. For this reason, the thickening suppressing effect was not exerted.

For Comparative Examples 3, 16, 29, 42, 55, and 68, the expression (2) exceeded the upper limit. For this reason, the wettability was inferior.

For Comparative Examples 4, 5, 17, 18, 30, 31, 43, 44, 56, 57, 69, and 70, the As content and the expression (2) exceeded the upper limits. For this reason, the result of inferior wettability was shown.

For Comparative Examples 6 to 8, 19 to 21, 32 to 34, 45 to 47, 58 to 60, and 71 to 73, the Sb content exceeded the upper limit. For this reason, the wettability was inferior.

Comparative Examples 9, 10, 22, 23, 35, 36, 48, 49, 61, 62, 74, and 75, the Bi content exceeded the upper limit. For this reason, the result of the ΔT of more than 10° C. was shown.

For Comparative Examples 11, 13, 24, 26, 37, 39, 50, 52, 63, 65, 76, and 78, the Pb content exceeded the upper limit. For this reason, the result of the ΔT of more than 10° C. was shown.

Comparative Examples 12, 25, 38, 51, 64, and 77 did not include Bi and Pb, so that the expression (2) was not held. For this reason, the wettability was inferior.

Further, when each Example was allowed to include a zirconium oxide powder with a particle size of 1 μm in an amount of 0.1%, the improvement of the thickening suppressing effect could be observed.

1. A solder alloy comprising an alloy composition including at least one of As: 25 to 300 mass ppm, Pb: more than 0 mass ppm and 5100 mass ppm or less, and Sb: more than 0 mass ppm and 3000 mass ppm or less, and moreover Bi: more than 0 mass ppm and 10000 mass ppm or less, as well as a balance including Sn, wherein expression (1) and expression (2) below are satisfied:
275≤2As+Sb+Bi+Pb (1)
0.01≤(2As+Sb)/(Bi+Pb)≤10.00 (2)
where in the expression (1) and the expression (2), As, Sb, Bi, and Pb each represent a content (mass ppm) in the alloy composition.

2. The solder alloy according to claim 1, wherein the alloy composition further satisfies expression (1a) below:
275≤2As+Sb+Bi+Pb≤25200 (1a)
where in the expression (1a), As, Sb, Bi, and Pb each represent a content (mass ppm) in the alloy composition.

3. The solder alloy according to claim 1, wherein the alloy composition further satisfies expression (1b) below:
275≤2As+Sb+Bi+Pb≤5300 (1b)
where in the expression (1b), As, Bi, and Pb each represent a content (mass ppm) in the alloy composition.

4. The solder alloy according to claim 1, wherein the alloy composition further satisfies expression (2a) below:
0.31≤(2As+Sb)/(Bi+Pb)≤10.00 (2a)
where in the expression (2a), As, Sb, Bi, and Pb each represent a content (mass ppm) in the alloy composition.

5. The solder alloy according to claim 1, wherein the alloy composition further comprises at least one of Ag: 0 to 4 mass % and Cu: 0 to 0.9 mass %.

6. A solder powder comprising the solder alloy according to claim 1.

7. A solder paste comprising the solder powder according to claim 6.

8. The solder paste according to claim 7, further comprising a zirconium oxide powder.

9. The solder paste according to claim 8, comprising the zirconium oxide powder in an amount of 0.05 to 20.0 mass % based on a total mass of the solder paste.

10. A solder joint comprising the solder alloy according to claim 1.
